(19) United States
(12) Patent Application Publication
(10) Pub. No.: US 2015/0350674 A1
(43) Pub. Date: Dec. 3, 2015

(54) Method and apparatus for block encoding in video coding and decoding

(71) Applicant: CANON KABUSHIKI KAISHA, Tokyo (JP)

(72) Inventors: Guillaume LAROCHE, SAINT AUBIN D'AUBIGNE (FR); Christophe GISQUET, ACIGNE (FR); Patrice ONNO, Rennes (FR)

(21) Appl. No.: 14/724,608

(22) Filed: May 28, 2015

(30) Foreign Application Priority Data
May 30, 2014 (GB) GB1409634.1

(51) Int. Cl. H04N 19/593; H04N 19/52

(52) U.S. Cl. CPC H04N 19/593; H04N 19/52

(57) ABSTRACT

A method of encoding a block of pixels in an image to be encoded using INTRA block copy prediction in which the block of pixels is encoded using a predictor block, said predictor block corresponding to a block pixels in the image. Calculating a cost for each of a plurality of candidate predictor blocks. Which of the candidate predictor blocks to use as a predictor block for encoding the block of pixels is determined based on the calculated costs. Calculating the cost includes, calculating a vector coding cost for each of a plurality of candidate block vector predictors, by calculating the difference between a block vector indicating the candidate predictor block and the candidate block vector predictor and determining the cost of coding the difference, and using the lowest calculated vector coding cost. The cost calculated for each of the predictor blocks may, for example, be a rate-distortion cost.

### CROSS-REFERENCE TO RELATED APPLICATIONS

This application claims the benefit of priority under 35 U.S.C. §119(a)-(d) of United Kingdom Patent Application No. 1409634.1, filed on May 30, 2014 and titled “Intra block copy mode encoding choice”. The above cited patent application is incorporated herein by reference in its entirety.

### BACKGROUND OF THE INVENTION

1. Field of the Invention

The present invention concerns a method and a device for encoding or decoding blocks of pixels in the process of encoding or decoding a video. It concerns more particularly the encoding and decoding of blocks of pixels in Intra Block Copy mode and Inter mode of HEVC Screen Content extension.

It applies more particularly to a mode of coding where a block of pixel is predictively encoded based on a predictor block pertaining to the same image. This mode of encoding a block of pixel is generally referred to as INTRA Block Copy mode. It is considered as a tool candidate for the Screen content Extension of the High Efficiency Video Coding (HEVC: ISO/IEC 23008-2 MPEG-H Part 2/ ITU-T H.265) international standard and now in the Screen Content extension of the same.

2. Description of the Related Art

When encoding an image in a video sequence, the image is first divided into coding entities of pixels of equal size referred to as Coding Tree Block (CTB). The size of a Coding Tree Block is typically 64 by 64 pixels. Each Coding Tree Block may then be decomposed in a hierarchical tree of smaller blocks which size may vary and which are the actual blocks to encode. These smaller blocks to encode are referred to as Coding Unit (CU).

The encoding of a particular Coding Unit is typically predictive. This means that a predictor block is first determined. Next, the difference between the predictor block and the Coding Unit is calculated. This difference is called the residue. Next, this residue is compressed. The actual encoded information of the Coding Unit is made of some information to indicate the way of determining the predictor block and the compressed residue. Best predictor blocks are blocks as similar as possible to the Coding Unit in order to get a small residue that could be efficiently compressed.

Encoding may be lossy, meaning that information is lost in the encoding process. The decoded block of pixel is not exactly the same as the original Coding Unit. Typically the loss of information comes from a quantization applied to the residue before entropy coding. This quantization allows a higher compression rate at the price of the loss of accuracy. Typically, high frequencies, namely the high level of details, are removed in the block.

Encoding may be lossless, meaning that the residue is not quantized. This kind of encoding allows retrieving the exact copy of the original samples of the Coding Unit. The lossless encoding is obtained at the expense of compression rate which is much smaller compared to a lossy compression.

The coding mode is defined based on the method used to determine the predictor block for the predictive encoding method of a Coding Unit.

A first coding mode is referred to as INTRA mode. According to INTRA mode, the predictor block is built based on the value of pixels immediately surrounding the Coding Unit within the current image. It is worth noting that the predictor block is not a block of the current image but a construction. A direction is used to determine which pixels of the border are actually used to build the predictor block and how they are used. The idea behind INTRA mode is that, due to the general coherence of natural images, the pixels immediately surrounding the Coding Unit are likely to be similar to pixels of the current Coding Unit. Therefore, it is possible to get a good prediction of the value of pixels of the Coding Unit using a predictor block based on these surrounding pixels.

A second coding mode is referred to as INTER mode. According to INTER mode, the predictor block is a block of another image. The idea behind the INTER mode is that successive images in a sequence are generally very similar. The main difference comes typically from a motion between these images due to the scrolling of the camera or due to moving objects in the scene. The predictor block is determined by a vector giving its location in a reference image relatively to the location of the Coding Unit within the current image. This vector is referred to as a motion vector. According to this mode, the encoding of such Coding Unit using this mode comprises motion information comprising the motion vector and the compressed residue.

We focus in this document on a third coding mode called INTRA Block Copy mode. According to the INTRA Block Copy mode, the block predictor is an actual block of the current image. A block vector is used to locate the predictor block. This block vector gives the location in the current image of the predictor block relatively to the location of the Coding Unit in the same current image. It comes that this block vector shares some similarities with the motion vector of the INTER mode. It is sometime called motion vector by analogy. As there could not be a motion within an image, strictly speaking, and for the sake of clarity, in this document motion vector always refer to the INTER mode while block vector is used for the INTRA Block Copy mode.

The invention also concerns other INTRA modes like, for example, the String Matching mode. An example of the later is a method that copies non-rectangular runs of pixels from a position, said position being encoded as a displacement and predicted. This is why the notion of block of pixels is not restrained to rectangular blocks of pixels in this document. A block of pixels may have any particular form and in particular the non-rectangular runs of pixels used in the String Matching mode.

The causal principle is the principle that states that all information to decode a particular Coding Unit must be based on already reconstructed Coding Units. At encoding, the whole information may be considered as available. Namely, to encode a given Coding Unit it would be possible to use any information from the entire current images or from all decoded and available other images in the sequence. At decoding, things are different. The decoding of the current images is typically done by decoding sequentially all Coding Unit. The order of decoding follows typically a raster scan order, namely beginning in the upper left of the image, progressing from left to right and from top to bottom. It come that when decoding a given Coding Unit, only the part of the current image located up or left to the current Coding Unit has already been decoded. This is the only available information for the decoding of the current Coding Unit. This has to be taken into account at encoding. For example, a predictor block in INTRA Block Copy mode, should pertain to the part of the image that will be available at decoding.

In INTRA Block Copy mode, the block vector is encoded using the regular motion vector difference (MVD) coding. This encoding consists, for a component of the vector, in coding whether this component is zero, and if not, to encode its sign and its magnitude. Both components corresponding to the vertical and horizontal directions are encoded that way in a so called MVD syntax element. The MVD syntax element comprises both components MVDx and MVDy of the two dimensional block vector.

In a current implementation of the Intra Block Copy (IBC) mode, an IBC predictor block is signalled by a block vector which indicates a spatial displacement from a current block. In the current implementation the block vector is predicted by using the block vector of the last encoded IBC block as a block vector predictor. However, several proposals have been made to change this method to introduce a competition method whereby a plurality of block vector predictors are considered as candidates and the predictor to be used is chosen that has the lowest bit cost and is signalled by an index or other syntax coded in the bitstream.

In one such implementation, the last 3 block vectors used are utilised as predictor candidates. In another, the ‘Left’ and ‘Above’ block vectors are used as candidates. In both cases, the predictor block search for IBC uses a vector cost of encoding the first predictor from among those available to determine a rate-distortion cost for candidate predictor blocks. The best predictor from among those available for selection is only determined once the search for the predictor block is complete and the block vector indicating the displacement from the block being encoded to the predictor block has been determined.

The present invention has been devised with a view to effectively improving the coding efficiency of the Intra Block Copy mode.

### SUMMARY OF THE INVENTION

According to a first aspect of the invention there is provided a method of encoding a block of pixels in an image to be encoded using INTRA block copy prediction in which the block of pixels in the image is encoded using a predictor block indicated by a block vector, said predictor block corresponding to a block pixels in the image, the method comprising:

calculating a cost for each of a plurality of candidate predictor blocks in the image; and

determining which of the candidate predictor blocks to use as a predictor block for encoding the block of pixels based on the calculated costs, wherein

calculating the costs includes,

calculating a vector coding cost for each of a plurality of candidate block vector predictors, by calculating the difference between a block vector indicating the candidate predictor block and the candidate block vector predictor and determining the cost of coding the difference, and

using the lowest calculated vector coding cost to determine the cost of the candidate predictor block.

In an embodiment the costs of the candidate predictor blocks are rate-distortion costs. Accordingly, the process by which the predictor block is determined is modified which is advantageous because it provides a surprising improvement to the coding efficiency without an excessive increase in run-time at the encoder side.

In an embodiment, an absolute value of the difference calculated between the block vector indicating the candidate predictor block and the candidate block vector predictor is used to determine the vector coding cost for each of the candidate block vector predictors.

By determining the predictor costs based on an absolute value of the difference (i.e. the residual) the encoding run time can be reduced.

In an embodiment, the lowest calculated vector coding cost indicates a best candidate block vector predictor and calculating the rate-distortion value further comprises calculating a coding cost of the non-absolute difference between the block vector indicating the candidate predictor block and the best candidate block vector predictor and using that coding cost to determine the cost (e.g. rate distortion cost) of the candidate predictor block.

Therefore, by determining the full cost of the best predictor determined from the costs of the absolute differences an accurate (rate-distortion) cost for the predictor block being considered can still be calculated.

In an embodiment, the absolute value is of a difference between only horizontal components of the block vector indicating the predictor block and the block vector predictor respectively. This is advantageous in that it further decreases the run-time but still gives a good result in terms of giving a good estimate of the true cost of the candidate predictor block.

In a second aspect, the present invention provides a method of encoding a block of pixels in an image to be encoded using INTRA block copy prediction in which the block of pixels in the image is encoded using a predictor block indicated by a block vector, said predictor block corresponding to a block pixels in the image, the method comprising:

searching the image for a predictor block by determining costs for candidate blocks in the image and selecting a predictor block from the candidate blocks according to a cost criterion, wherein

determining each cost includes evaluating a vector coding cost corresponding to each available candidate block vector predictor. In an embodiment, the costs for the candidate blocks are rate-distortion costs

Accordingly, similar to the first aspect, in the second aspect the process by which the predictor block is determined is advantageously modified and provides a surprising improvement to the coding efficiency without an excessive increase in run-time at the encoder side.

In an embodiment evaluating the vector coding cost includes determining an absolute value of a residual between a block vector indicating a candidate block and a candidate block vector predictor.

In an embodiment the absolute value is of a residual between only the horizontal components of the block vector indicating the candidate block and the candidate block vector predictor.

In a third aspect of the invention there is provided an apparatus for encoding a block of pixels in an image to be encoded using INTRA block copy prediction in which the block of pixels in the image is encoded using a predictor block indicated by a block vector, said predictor block corresponding to a block pixels in the image, the apparatus comprising:

a calculation unit configured to calculate a cost for each of a plurality of candidate predictor blocks in the image; and

a determination unit configured to determine which of the candidate predictor blocks to use as a predictor block for encoding the block of pixels based on the calculated costs, wherein

the calculation unit is configured to calculate the costs by,

calculating a vector coding cost for each of a plurality of candidate block vector predictors, by calculating the difference between a block vector indicating the candidate predictor block and the candidate block vector predictor and determining the cost of coding the difference, and

using the lowest calculated vector coding cost to determine the rate-distortion value of the candidate predictor block.

In an embodiment, the calculation unit is configured to calculate a rate-distortion cost as the cost for each of the candidate predictor blocks in the image.

In an embodiment, the calculation unit is configured to calculate an absolute value of the difference calculated between the block vector indicating the candidate predictor block and the candidate block vector predictor and use that absolute value as the vector coding cost of each of the candidate block vector predictors.

In an embodiment, the lowest calculated vector coding cost indicates a best candidate block vector predictor and the calculation unit is further configured to calculate the cost of the candidate predictor block by calculating a coding cost of the non-absolute difference between the block vector indicating the candidate predictor block and the best candidate block vector predictor and using that coding cost to determine the cost of the candidate predictor block

In an embodiment, the absolute value is of a difference between only horizontal components of the block vector indicating the predictor block and the candidate block vector predictor respectively.

In a fourth aspect, there is provided an apparatus for encoding a block of pixels in an image to be encoded using INTRA block copy prediction in which the block of pixels in the image is encoded using a predictor block indicated by a block vector, said predictor block corresponding to a block pixels in the image, the apparatus comprising:

a search unit configured to search the image for a predictor block by determining costs for candidate blocks in the image and to select a predictor block from the candidate blocks according to cost criterion, wherein

determining the costs includes evaluating a vector coding cost corresponding to each available candidate block vector predictor.

In an embodiment, the search unit is configured to determine rate-distortion costs as the costs for candidate blocks for the image.

In an embodiment, the search unit is configured to evaluate the vector coding cost by determining an absolute value of a residual between a block vector indicating a candidate block and a candidate block vector predictor.

In an embodiment, the search unit is configured to determine the absolute value of a residual between only horizontal components of the block vector indicating the candidate block and the candidate block vector predictor respectively.

In a fifth aspect, the present invention provides an encoder for encoding a sequence of digital images into a bitstream comprising an encoding unit configured to encode a block of pixels in an image to be encoded using INTRA block copy prediction in which the block of pixels in the image is encoded using a predictor block indicated by a block vector, said predictor block corresponding to a block pixels in the image, the encoding unit comprising:

a calculation unit configured to calculate a cost for each of a plurality of candidate predictor blocks in the image; and

a determination unit configured to determine which of the candidate predictor blocks to use as a predictor block for encoding the block of pixels based on the calculated costs, wherein

the calculation unit is configured to calculate the costs for each plurality of candidate predictors blocks by, calculating a vector coding cost for each of a plurality of candidate block vector predictors, by calculating the difference between a block vector indicating the candidate predictor block and the candidate block vector predictor and determining the cost of coding the difference, and

using the lowest calculated vector coding cost to determine the cost of the candidate predictor block.

In a sixth aspect, the present invention provides an encoder for encoding a sequence of digital images into a bitstream comprising an encoding unit configured to encode a block of pixels in an image to be encoded using INTRA block copy prediction in which the block of pixels in the image is encoded using a predictor block indicated by a block vector, said predictor block corresponding to a block pixels in the image, the encoding unit comprising:

a search unit configured to search the image for a predictor block by determining costs for candidate blocks in the image and to select a predictor block from the candidate blocks according to a cost criterion, wherein

determining the costs includes evaluating a vector coding cost corresponding to each available candidate block vector predictor.

In embodiments of the first to sixth aspects, candidate block vector predictors include or consist of the last three block vectors used when applying the INTRA block copy prediction method. In another embodiment the candidate block vector predictors are block vectors associated with blocks spatially located above and to the left of the block being coded said above and left blocks being adjacent to the block being coded. In other embodiments, different candidate block vector predictors may be used, for example, the method of generating a set of candidate motion vectors as applied in the Inter mode of HEVC may be applied to generate a set of block vector candidates for INTRA block copy prediction.

In a further aspect of the present invention there is provided a method of encoding a block of pixels in an image to be encoded using INTRA block copy prediction in which the block of pixels in the image is encoded using a predictor block indicated by a block vector, said predictor block corresponding to a block pixels in the image, the method comprising:

searching the image for a predictor block by determining costs for candidate blocks in the image and selecting a predictor block from the candidate blocks according to a cost criterion, wherein

determining the rate-distortion value includes evaluating a vector coding cost of at least one candidate block vector predictor for the candidate block, and

if the candidate block vector predictor indicates a position in the image outside a two coding tree block range the vector coding cost of the candidate block vector is evaluated. The determined costs may be rate-distortion costs for the candidate blocks.

By having predictors that point to locations outside the 2CTBs range considered, in the 2 CTBs search, an improvement in coding efficiency may be obtained. More generally, this improves the coding efficiency by not unnecessarily excluding certain candidate block vector predictors from consideration when searching for a predictor block.

In a further aspect there is provided an apparatus for encoding a block of pixels in an image to be encoded using INTRA block copy prediction in which the block of pixels in the image is encoded using a predictor block indicated by a block vector, said predictor block corresponding to a block pixels in the image, the apparatus comprising:

a searching unit configured to search the image for a predictor block by determining costs for candidate blocks in the image and selecting a predictor block from the candidate blocks according to a cost criterion, wherein

determining the costs includes evaluating a vector coding cost of at least one candidate block vector predictor for the candidate block, and if the candidate block vector predictor indicates a position in the image outside a two coding tree block range the vector coding cost of the candidate block vector is evaluated. The determined costs may be rate-distortion costs for the candidate blocks.

In a further aspect of the present invention there is provided a method of encoding a block of pixels in an image to be encoded using INTRA block copy prediction in which the block of pixels in the image is encoded using a predictor block indicated by a block vector, said predictor block corresponding to a block pixels in the image, the method comprising:

searching the image for a predictor block by determining costs for candidate blocks in the image and selecting a predictor block from the candidate blocks according to costs criterion, and

determining the costs includes evaluating a vector coding cost of at least one candidate block vector predictor for the candidate block, and

in a case that the block size of the block of pixels to be encoded is 64×64 or 32×32, the candidate blocks searched include three predictor blocks indicated by the last three block vectors used by the Intra Block copy prediction method. The costs may be rate-distortion costs

In another aspect in a case that the block size of the block of pixels to be encoded is a non-square block size 64×32, 32×64, 32×16, and 16×32, the candidate blocks searched includes the last three predictor blocks used by the Intra Block Coding method.

In a further aspect, in only a case where the block size of the block of pixels to be encoded corresponds to a maximum transform size the candidate blocks searched includes the last three predictor blocks used by the Intra Block Coding method.

By using the last 3 block vectors used for IBC (i.e. the last 3 predictor blocks) for the bigger block sizes a significant improvement in coding efficiency can be achieved with only a small increase in run-time at the encoder side.

In another aspect, the present invention provides an apparatus for encoding a block of pixels in an image to be encoded using INTRA block copy prediction in which the block of pixels in the image is encoded using a predictor block indicated by a block vector, said predictor block corresponding to a block pixels in the image, the method comprising:

searching the image for a predictor block by determining costs for candidate blocks in the image and selecting a predictor block from the candidate blocks according to a cost criterion, wherein

determining the costs includes evaluating a vector coding cost of at least one candidate block vector predictor for the candidate block, and

in a case that the block size of the block of pixels to be encoded is 64×64 or 32×32, the candidate blocks searched include three predictor blocks indicated by the last three block vectors used by the Intra Block copy prediction method. The determined costs may be rate-distortion costs for the candidate blocks.

In another aspect the apparatus is configured so that in a case that the block size of the block of pixels to be encoded is a non-square block size 64×32, 32×64, 32×16, and 16×32, the candidate blocks searched includes the last three predictor blocks used by the Intra Block Coding method.

In a further aspect, the apparatus is configured so that only in a case where the block size of the block of pixels to be encoded corresponds to a maximum transform size the candidate blocks searched includes the last three predictor blocks used by the Intra Block Coding method.

In other aspects of the invention, there is provided a method of encoding a sequence of digital images into a bitstream comprising encoding a block of pixels according to the method aspects described above. In other aspects of the invention, there is provided a method of decoding a bitstream that has been encoded, or has a block that has been encoded, according to any of the respective method aspects described above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

The invention, in at least some aspects, relates to a method of encoding a sequence of images into a bitstream. Such a bitstream may be provided or carried on a tangible carrier medium such as a solid state memory device, hard disk drive, floppy disk, magnetic tape device, CD-ROM, DVD, Blu-Ray disc or the like. The bitstream may be read from the tangible carrier medium by a computer or any other apparatus, such as a decoder, capable of reading the bitstream.

### BRIEF DESCRIPTION OF THE DRAWINGS

Embodiments of the invention will be described, by way of example only, and with reference to the following drawings in which:

FIG. 1 illustrates the HEVC encoder architecture;

FIG. 2 illustrates the HEVC decoder architecture;

FIG. 3 illustrates the neighboring positions blocks used to generate motion vector predictors in AMVP and Merge of HEVC;

FIG. 4 illustrates the derivation process of motion vector predictors in AMVP;

FIG. 5 illustrates the derivation process of motion candidates in Merge;

FIG. 6 illustrates the Level decomposition of Video frame;

FIG. 7 illustrates the Coding Tree Block splitting in Coding Units and the scan order decoding of these Coding Unit;

FIG. 8 illustrates the concept of the causal area;

FIG. 9 illustrates the Intra Block Copy search area;

FIG. 10 illustrates the block vector cost computation during the block vector estimation;

FIG. 11 illustrates the block vector cost computation during the block vector estimation in an embodiment of the invention;

FIG. 12 illustrates the block vector cost computation during the block vector estimation in another embodiment of the invention;

FIG. 13 is a schematic block diagram of a computing device for implementation of one or more embodiments of the invention.

### DETAILED DESCRIPTION OF THE INVENTION

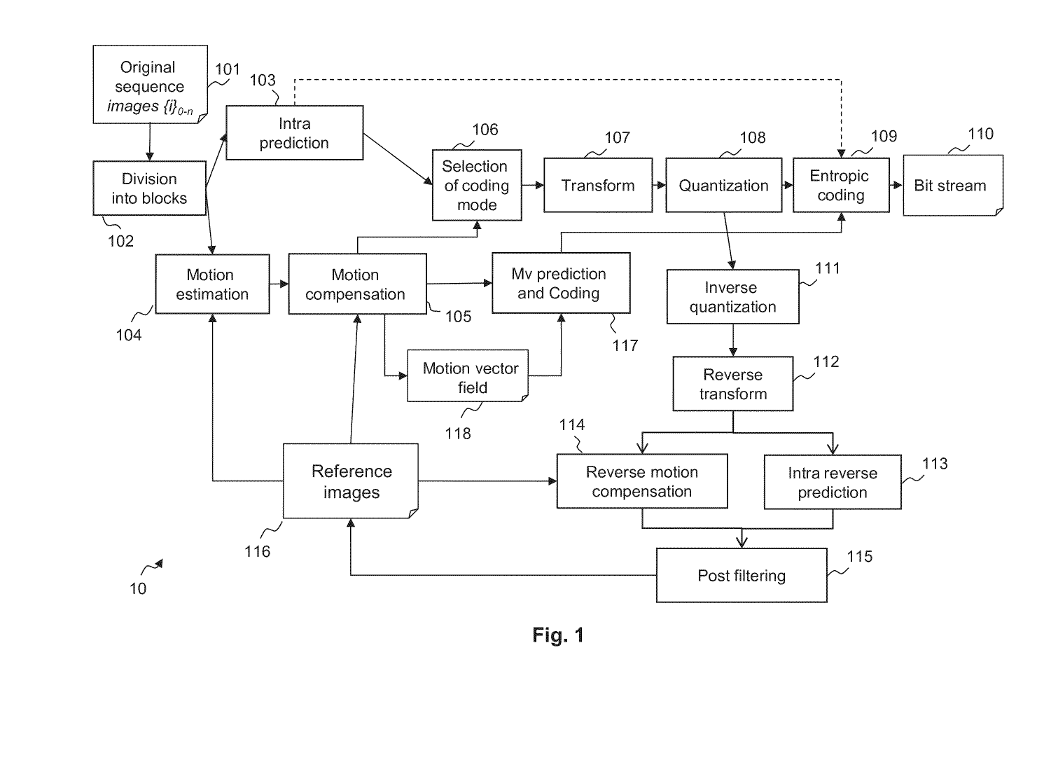

FIG. 1 illustrates the HEVC encoder architecture. In the video encoder, an original sequence 101 is divided into blocks of pixels 102. A coding mode is then affected to each block. There are two families of coding modes typically used in HEVC: the modes based on spatial prediction or INTRA modes 103 and the modes based on temporal prediction or INTER modes based on motion estimation 104 and motion compensation 105. An INTRA Coding Unit is generally predicted from the encoded pixels at its causal boundary by a process called INTRA prediction.

Temporal prediction first consists in finding in a previous or future frame called the reference frame 116 the reference area which is the closest to the Coding Unit in a motion estimation step 104. This reference area constitutes the predictor block. Next this Coding Unit is predicted using the predictor block to compute the residue in a motion compensation step 105.

In both cases, spatial and temporal prediction, a residual is computed by subtracting the Coding Unit from the original predictor block.

In the INTRA prediction, a prediction direction is encoded. In the temporal prediction, at least one motion vector is encoded. However, in order to further reduce the bitrate cost related to motion vector encoding, a motion vector is not directly encoded. Indeed, assuming that motion is homogeneous, it is particularly interesting to encode a motion vector as a difference between this motion vector, and a motion vector in its surrounding. In H.264/AVC coding standard for instance, motion vectors are encoded with respect to a median vector computed between 3 blocks located above and on the left of the current block. Only a difference, also called residual motion vector, computed between the median vector and the current block motion vector is encoded in the bitstream. This is processed in module “Mv prediction and coding” 117. The value of each encoded vector is stored in the motion vector field 118. The neighboring motion vectors, used for the prediction, are extracted from the motion vector field 118.

Then, the mode optimizing the rate distortion performance is selected in module 106. In order to further reduce the redundancies, a transform, typically a DCT, is applied to the residual block in module 107, and a quantization is applied to the coefficients in module 108. The quantized block of coefficients is then entropy coded in module 109 and the result is inserted in the bitstream 110.

The encoder then performs a decoding of the encoded frame for the future motion estimation in modules 111 to 116. These steps allow the encoder and the decoder to have the same reference frames. To reconstruct the coded frame, the residual is inverse quantized in module 111 and inverse transformed in module 112 in order to provide the “reconstructed” residual in the pixel domain. According to the encoding mode (INTER or INTRA), this residual is added to the INTER predictor 114 or to the INTRA predictor 113.

Then, this first reconstruction is filtered in module 115 by one or several kinds of post filtering. These post filters are integrated in the encoded and decoded loop. It means that they need to be applied on the reconstructed frame at encoder and decoder side in order to use the same reference frame at encoder and decoder side. The aim of this post filtering is to remove compression artifacts.

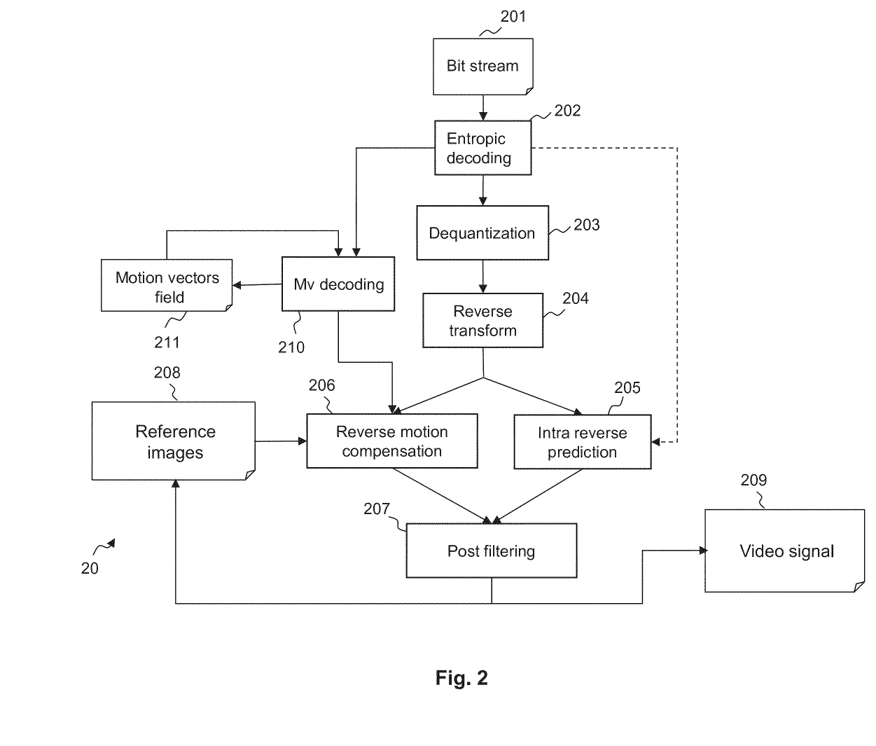

In FIG. 2, have been represented the principle of a decoder. The video stream 201 is first entropy decoded in a module 202. The residual data are then inverse quantized in a module 203 and inverse transformed in a module 204 to obtain pixel values. The mode data are also entropy decoded in function of the mode, an INTRA type decoding or an INTER type decoding is performed. In the case of INTRA mode, an INTRA predictor is determined in function of the INTRA prediction mode specified in the bitstream 205. If the mode is INTER, the motion information is extracted from the bitstream 202. This is composed of the reference frame index and the motion vector residual. The motion vector predictor is added to the motion vector residual to obtain the motion vector 210. The motion vector is then used to locate the reference area in the reference frame 206. Note that the motion vector field data 211 is updated with the decoded motion vector in order to be used for the prediction of the next decoded motion vectors. This first reconstruction of the decoded frame is then post filtered 207 with exactly the same post filter as used at encoder side. The output of the decoder is the de-compressed video 209.

This INTRA Block Copy coding mode is particularly well suited for extremely repetitive patterns. In particular, it is known to help coding graphical elements such as glyphs, the graphical representation of a character, or traditional GUI elements, which are very difficult to code using traditional INTRA prediction methods.

It is worth noting that prediction is based on coherence between neighbor Coding Units. This coherence may be geographic when considered within the current frame or temporal when considered across successive frames. This kind of coherence occurs in natural images. As INTRA Block Copy encoding mode is seen as a mode dedicated to text or symbolic images, predication is thought as useless for this kind of image. For instance, there is no reason to have two successive Coding Units in an image representing a text having good predictors close to each other. The first Coding Unit may be the part of letter “A”, a good predictor block would therefore come from another “A” in the text. While the next Coding Unit would be a “P” letter having a predictor block from another “P” in the text. There is no reason, a-priori, to have the two predictor blocks in the same neighborhood. This is why prior art does not contemplate introducing prediction in INTRA Block Copy encoding mode.

The current design of HEVC uses 3 different INTER modes: the Inter mode, the Merge mode and the Merge Skip mode. The main difference between these modes is the data signaling in the bitstream. For the Motion vector coding, the current HEVC standard includes a competitive based scheme for Motion vector prediction compared to its predecessors. It means that several candidates are competing with the rate distortion criterion at encoder side in order to find the best motion vector predictor or the best motion information for respectively the Inter or the Merge mode. An index corresponding to the best predictors or the best candidate of the motion information is inserted in the bitstream. The decoder can derive the same set of predictors or candidates and uses the best one according to the decoded index.

The design of the derivation of predictors and candidate is very important to achieve the best coding efficiency without large impact on complexity. In HEVC two motion vector derivations are used: one for Inter mode (Advanced Motion Vector Prediction (AMVP)) and one for Merge modes (Merge derivation process). The following describes these processes.

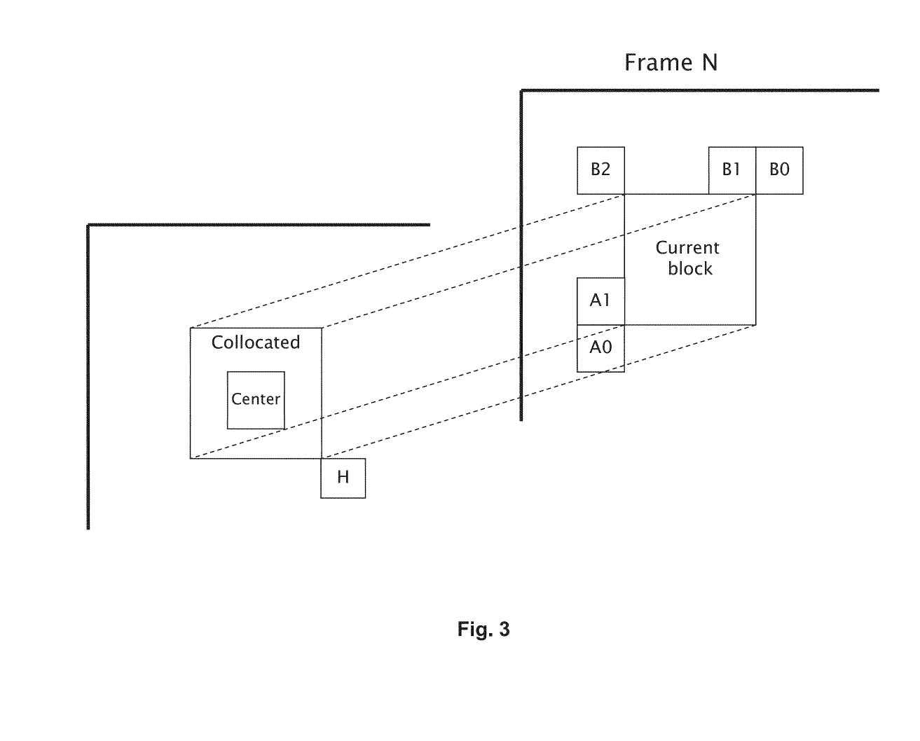

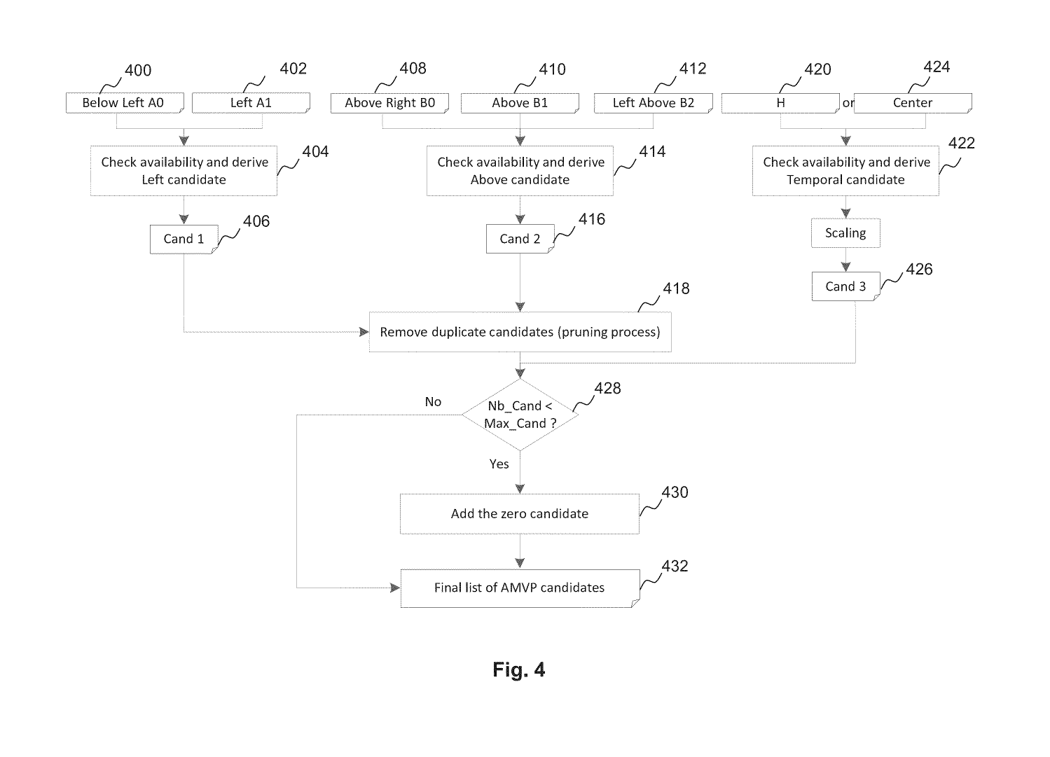

FIG. 3 illustrates spatial and temporal blocks that can be used to generate motion vector predictors in Advanced Motion Vector Prediction (AMVP) and Merge modes of HEVC coding and decoding systems and FIG. 4 shows simplified steps of the process of the AMVP predictor set derivation.

Two predictors, i.e. the two spatial motion vectors of the AMVP mode, are chosen among the top blocks and the left blocks including the top corner blocks and left corner block and one predictor is chosen among the bottom right block and center block of the collocated block as represented in FIG. 3.

FIG. 3 illustrates spatial and temporal blocks that can be used to generate motion vector predictors in Advanced Motion Vector Prediction (AMVP) and Merge modes of HEVC coding and decoding systems and FIG. 4 shows simplified steps of the process of the AMVP predictor set derivation.

Two predictors, i.e. the two spatial motion vectors of the AMVP mode, are chosen among the top blocks and the left blocks including the top corner blocks and left corner block and one predictor is chosen among the bottom right block and center block of the collocated block as represented in FIG. 3.

Turning to FIG. 4, a first step aims at selecting a first spatial predictor (Cand 1, 406) among the bottom left blocks A0 and A1, that spatial positions are illustrated in FIG. 3. To that end, these blocks are selected (400, 402) one after another, in the given order, and, for each selected block, following conditions are evaluated (404) in the given order, the first block for which conditions are fulfilled being set as a predictor:

the motion vector from the same reference list and the same reference image;

the motion vector from the other reference list and the same reference image;

the scaled motion vector from the same reference list and a different reference image; or

the scaled motion vector from the other reference list and a different reference image.

If no value is found, the left predictor is considered as being unavailable. In this case, it indicates that the related blocks were INTRA coded or those blocks do not exist.

A following step aims at selecting a second spatial predictor (Cand 2, 416) among the above right block B0, above block B1, and left above block B2, that spatial positions are illustrated in FIG. 3. To that end, these blocks are selected (408, 410, 412) one after another, in the given order, and, for each selected block, the above mentioned conditions are evaluated (414) in the given order, the first block for which the above mentioned conditions are fulfilled being set as a predictor.

Again, if no value is found, the top predictor is considered as being unavailable. In this case, it indicates that the related blocks were INTRA coded or those blocks do not exist.

In a next step (418), the two predictors, if both are available, are compared one to the other to remove one of them if they are equal (i.e. same motion vector values, same reference list, same reference index and the same direction type). If only one spatial predictor is available, the algorithm is looking for a temporal predictor in a following step.

The temporal motion predictor (Cand 3, 426) is derived as follows: the bottom right (H, 420) position of the collocated block in a previous frame is first considered in the availability check module 422. If it does not exist or if the motion vector predictor is not available, the center of the collocated block (Center, 424) is selected to be checked. These temporal positions (Center and H) are depicted in FIG. 3.

The motion predictor value is then added to the set of predictors. Next, the number of predictors (Nb_Cand) is compared (428) to the maximum number of predictors (Max_Cand). As mentioned above, the maximum number of predictors (MAX_Cand) of motion vector predictors that the derivation process of AMVP needs to generate is two in the current version of HEVC standard.

If this maximum number is reached, the final list or set of AMVP predictors (432) is built. Otherwise, a zero predictor is added (430) to the list. The zero predictor is a motion vector equal to (0,0).

As illustrated in FIG. 4, the final list or set of AMVP predictors (432) is built from a subset of spatial motion predictors (400 to 412) and from a subset of temporal motion predictors (420, 424).

As mentioned above, a motion predictor candidate of Merge mode or of Merge Skip mode represents all the required motion information: direction, list, reference frame index, and motion vectors. An indexed list of several candidates is generated by a merge derivation process. In the current HEVC design the maximum number of candidates for both Merge modes is equal to five (4 spatial candidates and 1 temporal candidate).

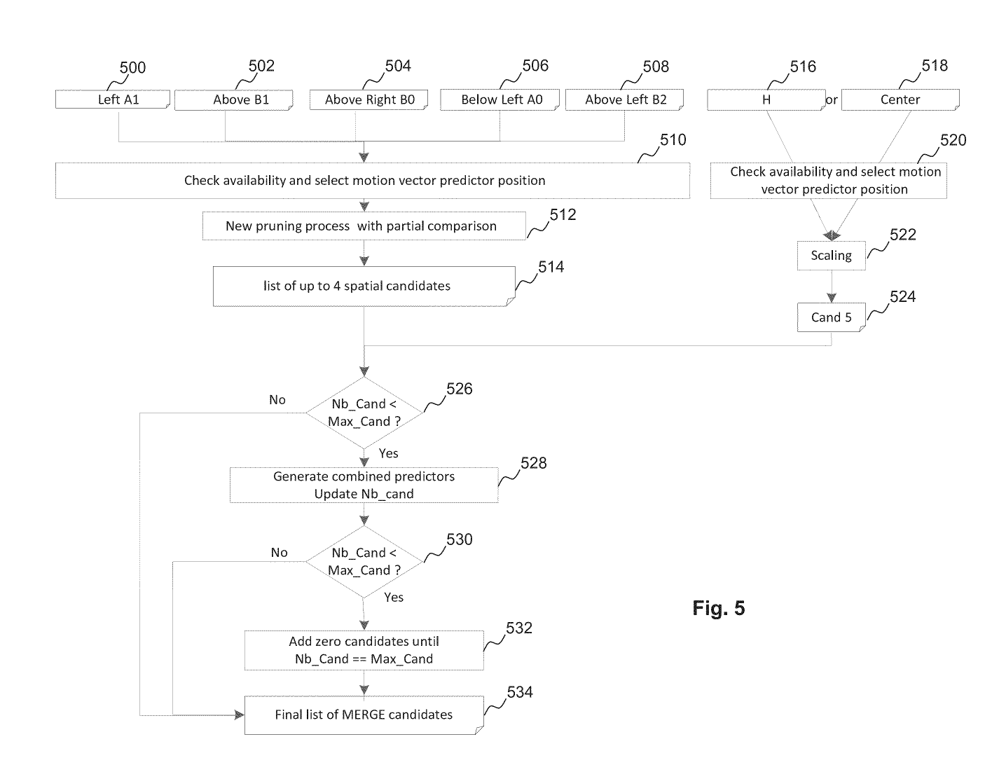

FIG. 5 is a schematic of a motion vector derivation process of the Merge modes. In a first step of the derivation process, five block positions are considered (500 to 508). These positions are the spatial positions depicted in FIG. 3 with references A1, B1, B0, A0, and B2. In a following step, the availability of the spatial motion vectors is checked and at most five motion vectors are selected (510). A predictor is considered as available if it exists and if the block is not INTRA coded. Therefore, selecting the motion vectors corresponding to the five blocks as candidates is done according to the following conditions:
if the “left” A1 motion vector (500) is available (510), i.e. if it exists and if this block is not INTRA coded, the motion vector of the “left” block is selected and used as a first candidate in list of candidate (514);
if the “above” B1 motion vector (502) is available (510), the candidate “above” block motion vector is compared to “left” A1 motion vector (512), if it exists. If B1 motion vector is equal to A1 motion vector, B1 is not added to the list of spatial candidates (514). On the contrary, if B1 motion vector is not equal to A1 motion vector, B1 is added to the list of spatial candidates (514);
if the “above right” B0 motion vector (504) is available (510), the motion vector of the “above right” is compared to B1 motion vector (512). If B0 motion vector is equal to B1 motion vector, B0 motion vector is not added to the list of spatial candidates (514). On the contrary, if B0 motion vector is not equal to B1 motion vector, B0 motion vector is added to the list of spatial candidates (514);
if the “below left” A0 motion vector (506) is available (510), the motion vector of the “below left” is compared to A1 motion vector (512). If A0 motion vector is equal to A1 motion vector, A0 motion vector is not added to the list of spatial candidates (514). On the contrary, if A0 motion vector is not equal to A1 motion vector, A0 motion vector is added to the list of spatial candidates (514); and
if the list of spatial candidates doesn't contain four candidates, the availability of “above left” B2 motion vector (508) is checked (510). If it is available, it is compared to A1 motion vector and to B1 motion vector. If B2 motion vector is equal to A1 motion vector or to B1 motion vector, B2 motion vector is not added to the list of spatial candidates (514). On the contrary, if B2 motion vector is not equal to A1 motion vector or to B1 motion vector, B2 motion vector is added to the list of spatial candidates (514).

At the end of this stage, the list of spatial candidates comprises up to four candidates.

For the temporal candidate, two positions can be used: the bottom right position of the collocated block (516, denoted H in FIG. 3) and the center of the collocated block (518). These positions are depicted in FIG. 3.

As for the AMVP motion vector derivation process, a first step aims at checking (520) the availability of the block at the H position. Next, if it is not available, the availability of the block at the center position is checked (520). If at least one motion vector of these positions is available, the temporal motion vector can be scaled (522), if needed, to the reference frame having index 0, for both list L0 and L1, in order to create a temporal candidate (524) which is added to the list of Merge motion vector predictor candidates. It is positioned after the spatial candidates in the list. The lists L0 and L1 are 2 reference frame lists containing zero, one or more reference frames.

If the number (Nb_Cand) of candidates is strictly less (526) than the maximum number of candidates (Max_Cand that value is signaled in the bit-stream slice header and is equal to five in the current HEVC design) and if the current frame is of the B type, combined candidates are generated (528). Combined candidates are generated based on available candidates of the list of Merge motion vector predictor candidates. It mainly consists in combining the motion vector of one candidate of the list L0 with the motion vector of one candidate of list L1.

If the number (Nb_Cand)of candidates remains strictly less (530) than the maximum number of candidates (Max_Cand), zero motion candidates are generated (532) until the number of candidates of the list of Merge motion vector predictor candidates reaches the maximum number of candidates.

At the end of this process, the list or set of Merge motion vector predictor candidates is built (534). As illustrated in FIG. 5, the list or set of Merge motion vector predictor candidates is built (534) from a subset of spatial candidates (500 to 508) and from a subset of temporal candidates (516, 518).

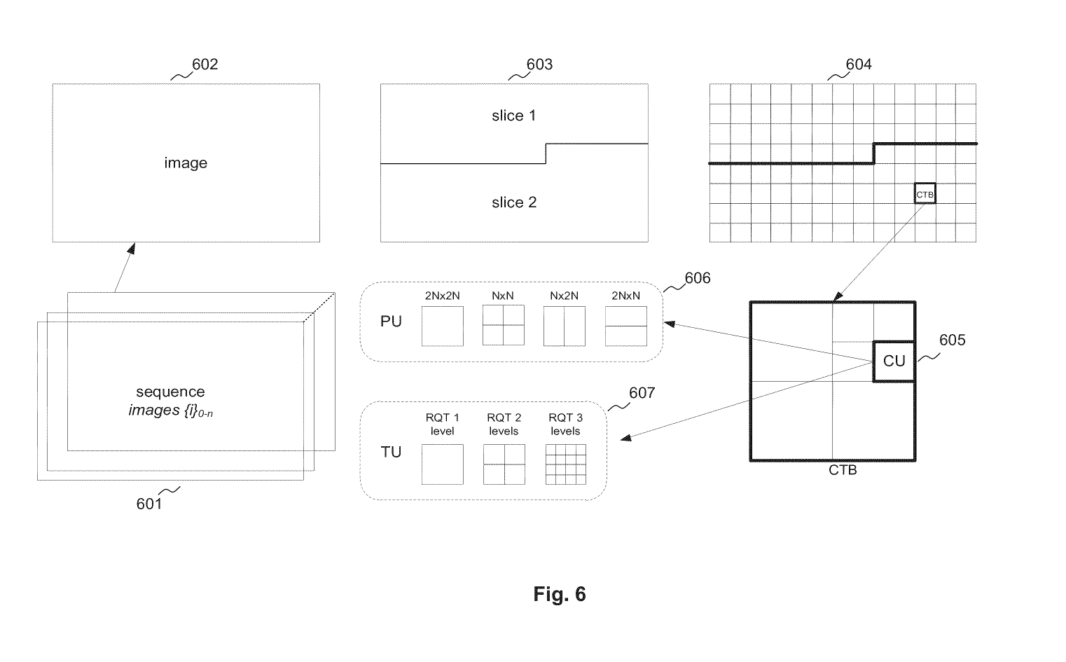

FIG. 6 shows the coding structure used in HEVC. According to HEVC and one of its previous predecessors, the original video sequence 601 is a succession of digital images “images i”. As is known per se, a digital image is represented by one or more matrices the coefficients of which represent pixels.

The images 602 are divided into slices 603. A slice is a part of the image or the entire image. In HEVC these slices are divided into non-overlapping Coding Tree Blocks (CTB) 604, generally blocks of size 64 pixels×64 pixels. Each CTB may in its turn be iteratively divided into smaller variable size Coding Units (CUs) 605 using a quadtree decomposition. Coding units are the elementary coding elements and are constituted of two sub units which Prediction Unit (PU) and Transform Units (TU) of maximum size equal to the CU's size. Prediction Unit corresponds to the partition of the CU for prediction of pixels values. Each CU can be further partitioned into a maximum of 4 square Partition Units or 2 rectangular Partition Units 606. Transform units are used to represent the elementary units that are spatially transform with DCT. A CU can be partitioned in TU based on a quadtree representation 607.

Each slice is embedded in one NAL unit. In addition, the coding parameters of the video sequence are stored in dedicated NAL units called parameter sets. In HEVC and H.264/AVC two kinds of parameter sets NAL units are employed: first, the Sequence Parameter Set (SPS) NAL unit that gathers all parameters that are unchanged during the whole video sequence. Typically, it handles the coding profile, the size of the video frames and other parameters. Secondly, Picture Parameter Sets (PPS) codes the different values that may change from one frame to another. HEVC include also Video Parameter Set (VPS) which contains parameters describing the overall structure of the stream.

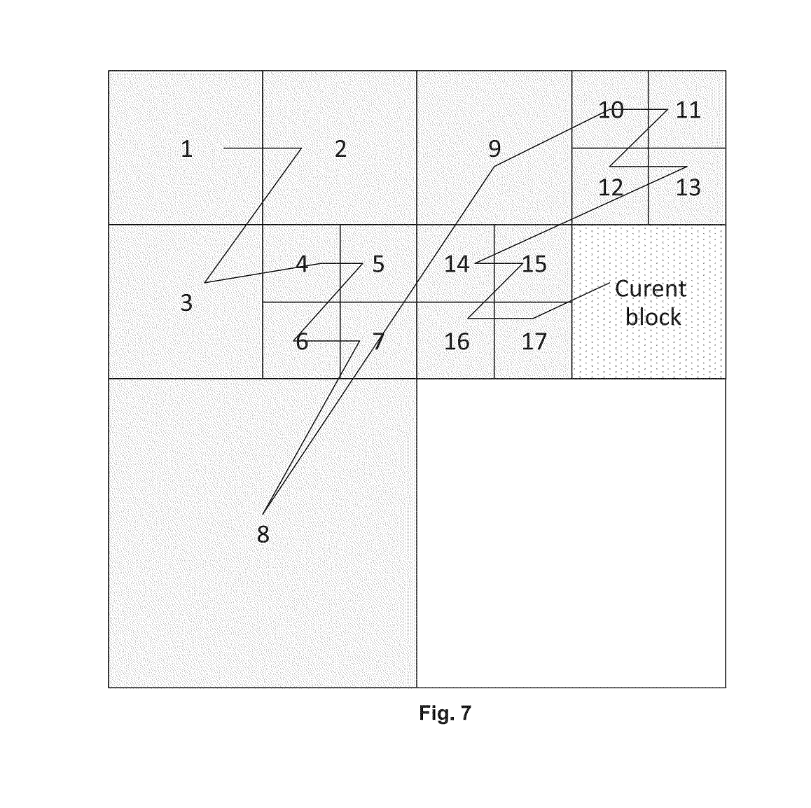

FIG. 7 illustrates the Coding Tree Block splitting in Coding Units and the scan order decoding of these Coding Units. In the HEVC standard, the block structure is organized by Coding Tree Block (CTB). A frame contains several non-overlapped and square Coding Tree Block. The size of a Coding Tree Block can be equal to 64×64 to 16×16. This size is determined at sequence level. The most efficient size, in term of coding efficiency, is the largest one: 64×64. Please note that all Coding Tree Block have the same size except for the image border. In that case, the size is adapted according to the amount of pixels.

Each Coding Tree Block contains one or more square Coding Units (CU). The Coding Tree Block is split based on a quad-tree structure into several Coding Units. The coding or decoding order of each Coding Unit in the Coding Tree Block follows the quad-tree structure based on a raster scan order. FIG. 7 shows an example of the decoding order of Coding Units. In this figure, the number in each Coding Unit gives the decoding order of each Coding Unit of this Coding Tree Block.

The Intra Block Copy (IBC) was added as an additional mode for Screen content coding extension of HEVC. This prediction method is particularly well suited for extremely repetitive patterns. In particular, it is known to help coding graphical elements such as glyphs (i.e., the graphical representation of a character) or traditional GUI elements, which are very difficult to code using traditional intra prediction methods.

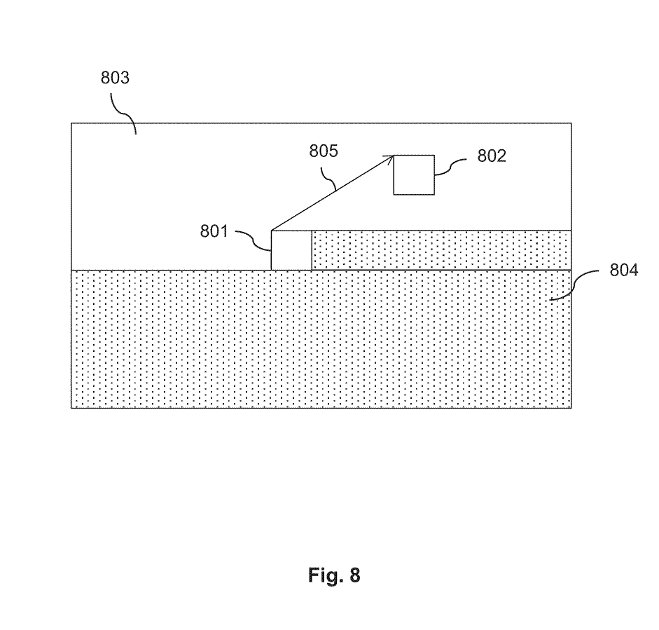

FIG. 8 illustrates how this Intra Block Copy prediction mode works. For example, this IBC prediction mode substitutes to the whole Intra prediction mode in the encoder or decoder illustrated in FIG. 1 or 2.

At a high-level, an image is divided into Coding Units that are encoded in raster scan order. Thus, when coding block 801, all the blocks of area 803 have already been encoded, and can be considered available to the encoder. Area 803 is called the causal area of the Coding Unit 801. Once Coding Unit 801 is encoded, it will belong to the causal area for the next Coding Unit. This next Coding Unit, as well as all the next ones, belongs to area 804 illustrated as doted area, and cannot be used for coding the current Coding Unit 801. It is worth noting that the causal area is constituted by reconstructed blocks. The information used to encode a given Coding Unit is not the original blocks of the image for the reason that this information is not available at decoding. The only information available at decoding is the reconstructed version of the blocks of pixels in the causal area, namely the decoded version of these blocks. For this reason, at encoding, previously encoded blocks of the causal area are decoded to provide this reconstructed version of these blocks.

INTRA Block Copy works by signaling a block 802 in the causal area which should be used to produce a prediction of block 801. For example, the block 802 may be found by using a matching algorithm. In the HEVC Screen content Extension, this block is indicated by a block vector 805, and is transmitted in the bitstream.

This block vector is the difference in coordinates between a particular point of the Coding Unit 801 and the equivalent point in the predictor block 802. Although it would be possible to use subpixel accuracy as for INTER blocks, this displacement is typically in integer units of pixels, therefore not to require costly subpixel interpolation. This vector is coded in the simplest way currently, the vector is not predicted, and the coordinates are coded using HEVC regular motion vector difference (MVD) coding.

Put in a simple way, the motion vector difference coding consists, for a value d, in coding whether d is zero, and if not, its sign and its magnitude minus 1. In HEVC motion vector difference coding interleaves the x and y components of the vector.

In the current IBC design, each IBC CU can be split into one or 2 PUs as depicted in FIG. 6. For the smallest CU size, 8×8, the CU can be also split into 4 PUs of 4×4 pixels each.

For Inter mode the N×N partition is not available. It means that the 4×4 block size can't be used for Inter mode. The following table summarizes the block size for both modes.

| Block sizes | | IBC mode | Inter mode |
|---|---|---|---|
| 64x64 | (2Nx2N) | ✓ | ✓ |
| 64x32 | (2NxN) | ✓ | ✓ |
| 32x64 | (Nx2N) | ✓ | ✓ |
| 32x32 | (2Nx2N) | ✓ | ✓ |
| 32x16 | (2NxN) | ✓ | ✓ |
| 16x32 | (Nx2N) | ✓ | ✓ |
| 16x16 | (2Nx2N) | ✓ | ✓ |
| 16x8 | (2NxN) | ✓ | ✓ |
| 8x16 | (Nx2N) | ✓ | ✓ |
| 8x8 | (2Nx2N) | ✓ | ✓ |
| 8x4 | (2NxN) | ✓ | ✓ |
| 4x8 | (Nx2N) | ✓ | ✓ |
| 4x4 | (NxN) | ✓ | |

In the current implementation of Intra Block Copy prediction mode, the search area depends on the blocks sizes. This is represented in the following table:

| | Full range search | | |
|---|---|---|---|
| Block size | (outside the 2CTB area) | 2 CTBs range search | Other |
| 64x64 | | | No search |
| 32x32 | | | No search |
| 16x16 | Classical IBC search | Classical IBC search | |
| 8x8 | Hash-based | Classical IBC search | |
| 4x8 | | Classical IBC search | |
| 8x4 | | Classical IBC search | |
| 4x4 | | Classical IBC search | |

For 2 CTBs search, if the predictor is not in the range of the 2 CTBs it is not evaluated and can't be selected. Consequently, when the predictor is not in the 2 CTBs range it is not evaluated for 4×8, 8×4, 4×4 and if the predictor is not in the hash list, it is not tested for hash search, so it is not evaluated for 8×8 block size.

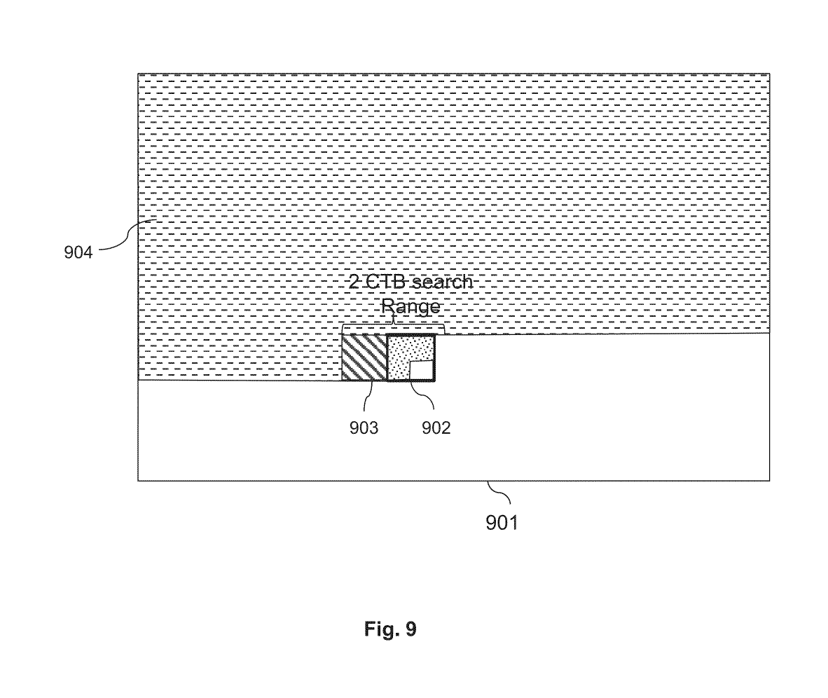

Please note that the 2N×N and N×2N PU sizes are tested only for 8×8 CUs in the current encoder implementation. These sizes are not depicted in this table. There are 2 types of Intra Block Copy block vector estimation. The first one is the classical IBC search and it corresponds to a dedicated block matching algorithm. The second one is based on the Hash search algorithm. Two search ranges are also defined. As depicted in FIG. 9, for a frame 901, the two CTBs search range corresponds to the left CTB 903 and to the blocks of the current CTB 902 already encoded. The blocks of current CTB already encoded are depicted in dotted area in FIG. 9. The full frame search corresponds to all the CTBs already encoded 904.

In the Intra Block Copy mode the “block” vector is the difference in coordinates between a particular point in a block A to encode and the equivalent point in the predictor block D of FIG. 8.

This block vector (BV) is itself predicted using the latest decoded block vector of the current Coding Tree Block. This vector predictor comes of course from the latest decoded Intra Block Copy block. Moreover, the block vector predictor is reset at the beginning of each Coding Tree Block by (N, 0) where N is the block size. Please note that other methods can be considered as for example the multiple last predictors with or without reset at Coding Tree Block level or at Coding Tree Block line. Moreover the left and the above vector can be also considered as the predictors for the current block. With these methods a predictor index is transmitted. It has been proposed to use 1 or 2 or 3 predictors for the Intra Block Copy (IBC) mode.

The vector residual, the difference between the current block vector and the predictor, is coded in the same way as the HEVC motion vector difference (MVD) coding of the Inter mode. The MVD coding consists, for a value d, in coding whether d is zero with a first flag, and if not, whether its absolute value (its magnitude) is 1 with a second flag. If its magnitude is not 1, then its magnitude minus 2 is then coded. In all case where the MVD is not zero, its sign is then coded. HEVC MVD coding interleaves for the x and y the aforementioned syntax elements components of the vector.

To select among the best set of parameters for the coding of the current block, the video encoders generally use the rate distortion selection. It consists in evaluating the rate of each set of parameters and the related distortion. The best set of parameters which minimizes the RD cost is selected. To avoid a very complex evaluation, the RD selection is not fully applied for all possible set of parameters.

In classical motion estimation (e.g. Inter mode in HEVC) the best temporal predictor for a current block is looked for. The best predictor means the best in term of rate distortion criterion. Conventionally, the rate distortion is estimated by checking the distortion between the block predictor and the current block and adding the cost of the motion vector. This avoids the full rate evaluation of the coding (block residual etc . . . ). Moreover, in the reference software of HEVC, the rate of the vector is evaluated as the following:

V_cost(V_{—}X, V_{—}Y)=GetBits(V_{—}X−Pred1_{—}X, V_{—}Y−Pred1_Y) (1)

where V_X is the horizontal component of a motion vector V, V_Y is the vertical component of the motion vector V, V_cost is the evaluated rate (cost) for the motion vector (V_X, V_Y), (Pred1_X, Pred1_Y) is the first predictor of a vector predictor list. (V_X−Pred1_X, V_Y−Pred1_Y) is a residual (i.e. difference) between the motion vector V and the first predictor Pred1.

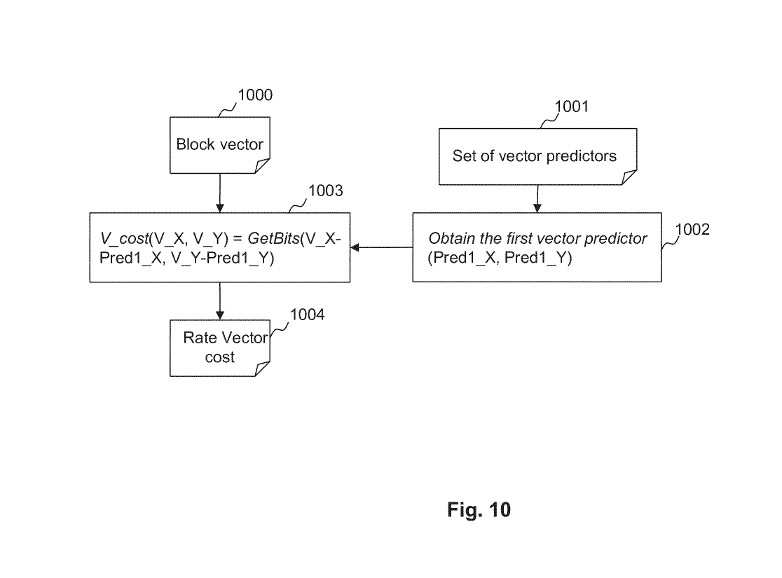

For the Intra block copy mode, the same evaluation is used for the block vector displacement (substituting ‘block vector’ for ‘motion vector’ in the expressions above. And some aspects of the invention are related to this aspect. FIG. 10 illustrates this process. Firstly, a block vector is selected for evaluation 1000. Also, a set of candidate block vector predictors that are to be available is established 1001. The first block vector predictor (Pred1_X, Pred1_Y) from the set of predictors is obtained 1002. The vector coding cost is calculated using the expression (1) given above 1003. This calculated value is then used as a rate vector cost to be added to the rate-distortion cost for the predictor block indicated by the block vector 1004.

According to an embodiment of the invention, we propose that, for INTRA Block Copy (IBC) mode, the best block vector (BV) predictor is estimated for all BV cost estimations especially during the block search. The present inventors have found that, when applied as described in the present embodiment, this gives a surprisingly significant 1% gain in coding efficiency. However, this modification increases the run time:

V_cost(V_{—}X, V_{—}Y)=Min(GetBits(RPred1_{—}X, RPred1_{—}Y), GetBits(RPred2_{—}X, RPred2_{—}Y), GetBits(RPred3_{—}X, RPred3_{—}Y)) (2)

where RPredi_X=V_X−Predi_X and RPredi_Y=V_Y−Predi_Y for all i=1. . . 3

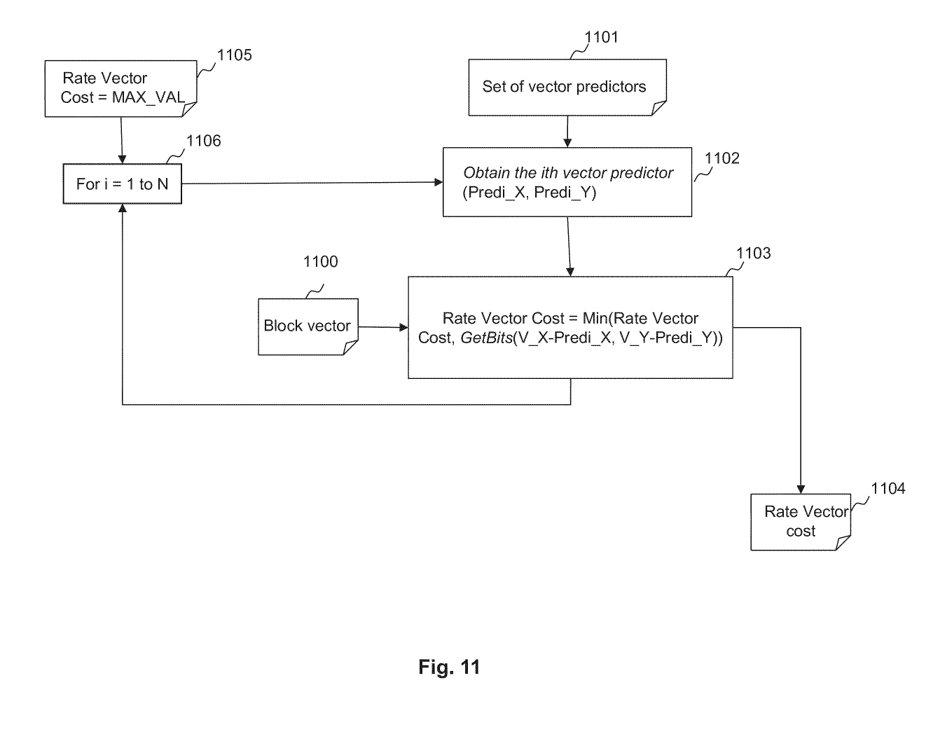

FIG. 11 illustrates this embodiment for a set of N predictors. This figure is based on FIG. 10. In particular, blocks 1100, 1101 and 1102 correspond to blocks 1000, 1001 and 1002 of FIG. 10. First the rate vector cost is initialized to the maximum value 1105. For each predictor (Predi_X, Predi_Y) 1002 in the set 1101 the related cost is evaluated 1103. The value rate vector cost is set to the minimum value between its own value and the cost related to the i^{th} predictor 1103. At the end of the process, the rate vector cost value 1104 is equal to the minimum value.

The previous embodiment increases the run time. To limit this run time increase, in one embodiment, the best predictor is determined based on the absolute value of each residual. The vector of this best predictor is then estimated as usual as illustrated with the following pseudo code for 3 predictors:

AbsRPredi = abs(RPredi_X) + abs(RPredi_Y) for all i where abs(x)

returns the absolute value of x.

If(AbsRPred1<AbsRPred2){

If(AbsRPred1<AbsRPred3)

V_cost(V_X, V_Y)=GetBits(RPred1_X, RPred1_Y)

else

V_cost(V_X, V_Y)= GetBits(RPred3_X, RPred3_Y)

}else{
If(AbsRPred2<AbsRPred3)

V_cost(V_X, V_Y)=GetBits(RPred2_X, RPred2_Y)

else

V_cost(V_X, V_Y)=GetBits(RPred3_X, RPred3_Y)

}

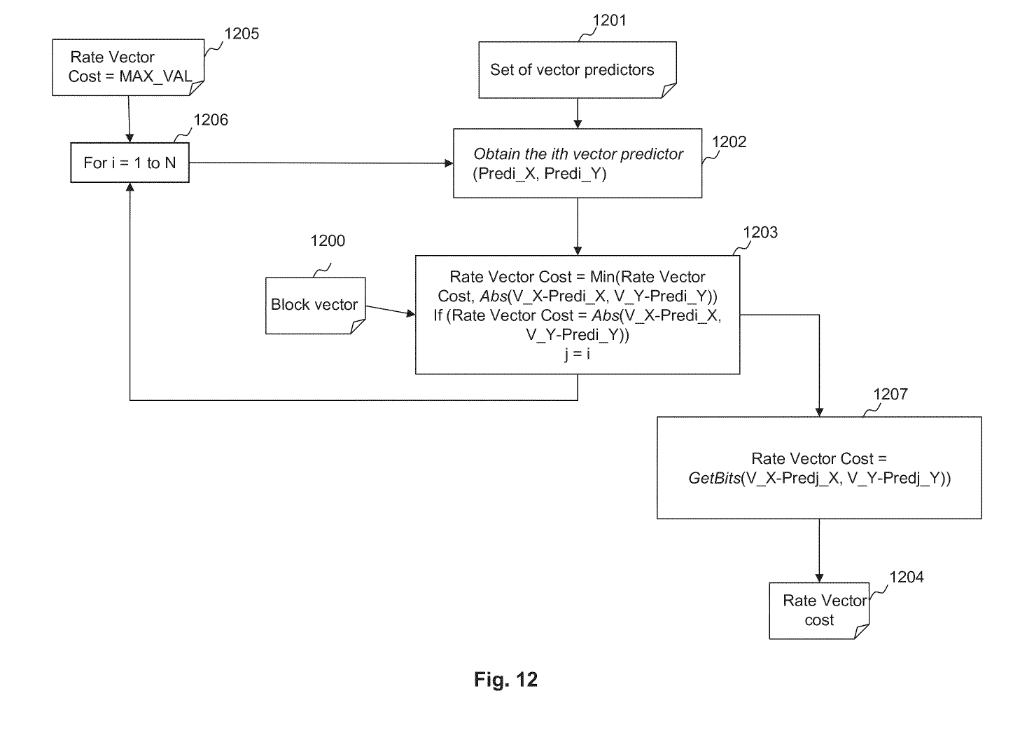

FIG. 12 illustrates this embodiment. It is the same as FIG. 11 except that the best predictor is obtained based on absolute difference evaluations 1202, 1203, 1206, in a manner substantially the same as outlined by the pseudo code above. The predictor j which minimizes the absolute cost 1203, is then fully evaluated 1207 to produce the real rate vector cost.

This embodiment reduces the encoding time because it reduces the number of calls to the “Getbits” function, which has a higher computational cost at the encoder than the absolute value function (Abs), and therefore runtime at the encoder side can be reduced.

The number of absolute values that need to be computed (and therefore the number of calls of the ‘Abs’ function) can be halved by setting AbsRPredi as being equal to the absolute value of RPrediX instead of RPrediX+RPrediY. In other words, according to the invention the best predictor is determined based on the value of the x predictor (RPrediX) only.

In the current design of the IBC search, the vector predictors are not evaluated if they are not in the range of the 2 CTBs and can't be selected. The 2 CTB search range is illustrated in FIG. 9.

According to another embodiment of the invention, the encoder is arranged to test predictors for the 2 CTBs search even when they are outside the 2 CTBs range. This means that all available predictors are tested and the coding efficiency is improved.

In an embodiment of the invention, the predictors list and only the predictors are evaluated for 64×64 and 32×32 block size. In particular, the IBC search is not used for 32×32 and 64×64 block size. This is due to the large increase of run time compared to the small gain obtained. Instead of using a full estimation or hash estimation or 2 CTBs estimation, according to an embodiment of the invention we test 3 block vectors (or in other words the last 3 predictor blocks used by IBC mode) for these 2 block sizes. This means that the 3 predictor blocks corresponding to the 3 positions pointed by the 3 last used block vectors are evaluated, (e.g. based on rate-distortion criteria),as the block predictor of the current block. This only requires a small amount of run time but the gain in coding efficiency obtained may be large. Other block predictors may also be searched in addition to the last three used block vectors. This may increase coding efficiency i.e. gain but at the price of an increased run-time at the encoder side.

To increase the gain, in another aspect of the invention, the predictor costs are evaluated for the non-square block sizes 64×32, 32×64, 32×16, 16×32.

In a further aspect of the invention, to reduce the encoding time the predictor costs are evaluated only for Maximum transform size and not for all transform sizes.

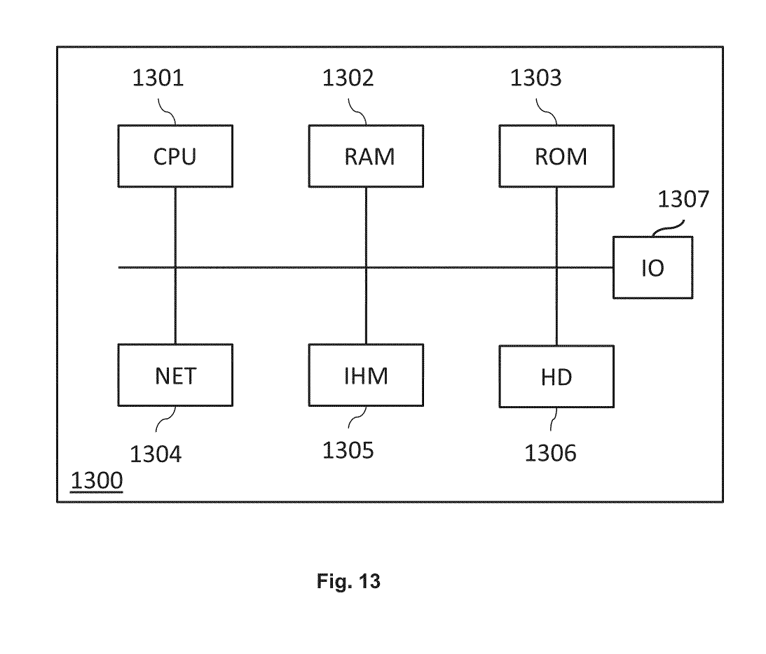

FIG. 13 is a schematic block diagram of a computing device 1300 for implementation of one or more embodiments of the invention. The computing device 1300 may be a device such as a micro-computer, a workstation or a light portable device. The computing device 1300 comprises a communication bus connected to:

a central processing unit 1301, such as a microprocessor, denoted CPU;

a random access memory 1302, denoted RAM, for storing the executable code of the method of embodiments of the invention as well as the registers adapted to record variables and parameters necessary for implementing the method for encoding or decoding at least part of an image according to embodiments of the invention, the memory capacity thereof can be expanded by an optional RAM connected to an expansion port for example;

a read only memory 1303, denoted ROM, for storing computer programs for implementing embodiments of the invention;

a network interface 1304 is typically connected to a communication network over which digital data to be processed are transmitted or received.

The network interface 1304 can be a single network interface, or composed of a set of different network interfaces (for instance wired and wireless interfaces, or different kinds of wired or wireless interfaces). Data packets are written to the network interface for transmission or are read from the network interface for reception under the control of the software application running in the CPU 1301;

a user interface 1305 may be used for receiving inputs from a user or to display information to a user;

a hard disk 1306 denoted HD may be provided as a mass storage device;

an I/O module 1307 may be used for receiving/sending data from/to external devices such as a video source or display.

The executable code may be stored either in read only memory 1303, on the hard disk 1306 or on a removable digital medium such as for example a disk. According to a variant, the executable code of the programs can be received by means of a communication network, via the network interface 1304, in order to be stored in one of the storage means of the communication device 1300, such as the hard disk 1306, before being executed.

The central processing unit 1301 is adapted to control and direct the execution of the instructions or portions of software code of the program or programs according to embodiments of the invention, which instructions are stored in one of the aforementioned storage means. After powering on, the CPU 1301 is capable of executing instructions from main RAM memory 1302 relating to a software application after those instructions have been loaded from the program ROM 1303 or the hard-disc (HD) 1306 for example. Such a software application, when executed by the CPU 1301, causes the steps of the flowcharts shown in FIGS. 1 to 4 to be performed.

Any step of the algorithm shown in FIGS. 1, 2, 4, 5, 10, 11, 12 may be implemented in software by execution of a set of instructions or program by a programmable computing machine, such as a PC (“Personal Computer”), a DSP (“Digital Signal Processor”) or a microcontroller; or else implemented in hardware by a machine or a dedicated component, such as an FPGA (“Field-Programmable Gate Array”) or an ASIC (“Application-Specific Integrated Circuit”).

Although the present invention has been described hereinabove with reference to specific embodiments, the present invention is not limited to the specific embodiments, and modifications will be apparent to a skilled person in the art which lie within the scope of the present invention. The scope of the following claims is to be accorded the broadest interpretation so as to encompass all such modifications and equivalent structures and functions.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encoding a block of pixels in an image to be encoded using INTRA block copy prediction in which the block of pixels in the image is encoded using a predictor block indicated by a block vector, said predictor block corresponding to a block pixels in the image, the method comprising:
calculating a cost for each of a plurality of candidate predictor blocks in the image; and
determining which of the candidate predictor blocks to use as a predictor block for encoding the block of pixels based on the calculated costs, wherein
calculating the cost includes,
calculating a vector coding cost for each of a plurality of candidate block vector predictors, by calculating the difference between a block vector indicating the candidate predictor block and the candidate block vector predictor and determining the cost of coding the difference, and
using the lowest calculated vector coding cost to determine the rate-distortion value of the candidate predictor block.

2. A method according to claim 1 wherein the cost comprises a rate-distortion cost.

3. A method according to claim 1 wherein an absolute value of the difference calculated between the block vector indicating the candidate predictor block and the candidate block vector predictor is used as the vector coding cost for each of the candidate block vector predictors.

4. A method according to claim 3 wherein the lowest calculated vector coding cost indicates a best candidate block vector predictor and calculating the rate-distortion value further comprises calculating a coding cost of the non-absolute difference between the block vector indicating the candidate predictor block and the best candidate block vector predictor and using that coding cost to determine the cost of the candidate predictor block.

5. A method according to claim 3 wherein the absolute value is of a difference between only horizontal components of the block vector indicating the predictor block and the block vector predictor respectively.

6. A method of encoding a sequence of digital images into a bitstream comprising encoding a block of pixels in an image to be encoded using INTRA block copy prediction in which the block of pixels in the image is encoded using a predictor block indicated by a block vector, said predictor block corresponding to a block pixels in the image, the method comprising:
calculating a cost for each of a plurality of candidate predictor blocks in the image; and
determining which of the candidate predictor blocks to use as a predictor block for encoding the block of pixels based on the calculated costs, wherein
calculating the cost includes,
calculating a vector coding cost for each of a plurality of candidate block vector predictors, by calculating the difference between a block vector indicating the candidate predictor block and the candidate block vector predictor and determining the cost of coding the difference, and
using the lowest calculated vector coding cost to determine the rate-distortion value of the candidate predictor block.

7. A method of encoding a block of pixels in an image to be encoded using INTRA block copy prediction in which the block of pixels in the image is encoded using a predictor block indicated by a block vector, said predictor block corresponding to a block pixels in the image, the method comprising:
searching the image for a predictor block by determining costs for candidate blocks in the image and selecting a predictor block from the candidate blocks according to a cost criterion, wherein
determining each cost includes evaluating a vector coding cost corresponding to each available candidate block vector predictor.

8. A method according to claim 7 wherein the costs determined for candidate blocks of the image are rate-distortion costs.

9. A method according to claim 7 wherein evaluating the vector coding cost includes determining an absolute value of a residual between a block vector indicating a candidate block and a candidate block vector predictor.

10. A method according to claim 9, wherein the absolute value is of a residual between only the horizontal components of the block vector indicating the candidate block and the candidate block vector predictor.

11. A method of encoding a sequence of digital images into a bitstream comprising encoding a block of pixels in an image using INTRA block copy prediction in which the block of pixels in the image is encoded using a predictor block indicated by a block vector, said predictor block corresponding to a block pixels in the image, the method comprising:
searching the image for a predictor block by determining costs for candidate blocks in the image and selecting a predictor block from the candidate blocks according to a cost criterion, wherein
determining each cost includes evaluating a vector coding cost corresponding to each available candidate block vector predictor.

12. An apparatus for encoding a block of pixels in an image to be encoded using INTRA block copy prediction in which the block of pixels in the image is encoded using a predictor block indicated by a block vector, said predictor block corresponding to a block pixels in the image, the apparatus comprising:
a calculation unit configured to calculate a cost for each of a plurality of candidate predictor blocks in the image; and
a determination unit configured to determine which of the candidate predictor blocks to use as a predictor block for encoding the block of pixels based on the calculated costs, wherein
the calculation unit is configured to calculate the costs by,
calculating a vector coding cost for each of a plurality of candidate block vector predictors, by calculating the difference between a block vector indicating the candidate predictor block and the candidate block vector predictor and determining the cost of coding the difference, and
using the lowest calculated vector coding cost to determine the rate-distortion value of the candidate predictor block.

13. An apparatus according to claim 12 where the calculation unit is configured to calculate a rate-distortion cost as the cost for each of the candidate predictor blocks in the image.

14. An apparatus according to claim 12 wherein the calculation unit is configured to calculate an absolute value of the difference calculated between the block vector indicating the candidate predictor block and the candidate block vector predictor and use that absolute value as the vector coding cost of each of the candidate block vector predictors.

15. An apparatus according to claim 14 wherein the lowest calculated vector coding cost indicates a best candidate block vector predictor and the calculation unit is further configured to calculate the cost of the candidate predictor block by calculating a coding cost of the non-absolute difference between the block vector indicating the candidate predictor block and the best candidate block vector predictor and using that coding cost to determine the cost of the candidate predictor block.

16. An apparatus according to claim 14 wherein the absolute value is of a difference between only horizontal components of the block vector indicating the predictor block and the candidate block vector predictor respectively.

17. An encoder for encoding a sequence of digital images into a bitstream comprising an encoding unit configured to encode a block of pixels in an image to be encoded using INTRA block copy prediction in which the block of pixels in the image is encoded using a predictor block indicated by a block vector, said predictor block corresponding to a block pixels in the image, the encoding unit comprising:
a calculation unit configured to calculate a cost for each of a plurality of candidate predictor blocks in the image; and
a determination unit configured to determine which of the candidate predictor blocks to use as a predictor block for encoding the block of pixels based on the calculated costs, wherein
the calculation unit is configured to calculate the costs for each plurality of candidate predictors blocks by,
calculating a vector coding cost for each of a plurality of candidate block vector predictors, by calculating the difference between a block vector indicating the candidate predictor block and the candidate block vector predictor and determining the cost of coding the difference, and
using the lowest calculated vector coding cost to determine the cost of the candidate predictor block.

18. An apparatus for encoding a block of pixels in an image to be encoded using INTRA block copy prediction in which the block of pixels in the image is encoded using a predictor block indicated by a block vector, said predictor block corresponding to a block pixels in the image, the apparatus comprising:
a search unit configured to search the image for a predictor block by determining costs for candidate blocks in the image and to select a predictor block from the candidate blocks according to cost criterion, wherein
determining the costs includes evaluating a vector coding cost corresponding to each available candidate block vector predictor.

19. An apparatus according to claim 18 wherein the search unit is configured to determine rate-distortion costs as the costs for candidate blocks for the image.

20. An apparatus according to claim 18 wherein the search unit is configured to evaluate the vector coding cost by determining an absolute value of a residual between a block vector indicating a candidate block and a candidate block vector predictor.

21. An apparatus according to claim 20, wherein search unit is configured to determine the absolute value of a residual between only horizontal components of the block vector indicating the candidate block and the candidate block vector predictor respectively.

22. An encoder for encoding a sequence of digital images into a bitstream comprising an encoding unit configured to encode a block of pixels in an image to be encoded using INTRA block copy prediction in which the block of pixels in the image is encoded using a predictor block indicated by a block vector, said predictor block corresponding to a block pixels in the image, the encoding unit comprising:
a search unit configured to search the image for a predictor block by determining costs for candidate blocks in the image and to select a predictor block from the candidate blocks according to a cost criterion, wherein
determining the costs includes evaluating a vector coding cost corresponding to each available candidate block vector predictor.

23. A method of decoding a bitstream encoded according to the method of claim 6 into a sequence of digital images.

24. A method of decoding a bitstream encoded according to the method of claim 11 into a sequence of digital images.

25. A non-transitory storage medium storing a bitstream encoded according to the method of claim 6.

26. A non-transitory storage medium storing a bitstream encoded according to the method of claim 11.

27. A non-transitory computer-readable storage medium containing processor executable instructions which upon execution by one or more processors of a computer cause the computer to perform a method of encoding a block of pixels in an image to be encoded using INTRA block copy prediction in which the block of pixels in the image is encoded using a predictor block indicated by a block vector, said predictor block corresponding to a block pixels in the image, the method comprising:
calculating a rate-distortion value for each of a plurality of candidate predictor blocks in the image; and
determining which of the candidate predictor blocks to use as a predictor block for encoding the block of pixels based on the calculated rate-distortion values, wherein
calculating the rate-distortion value includes,
calculating a vector coding cost for each of a plurality of candidate block vector predictors, by calculating the difference between a block vector indicating the candidate predictor block and the candidate block vector predictor and determining the cost of coding the difference, and
using the lowest calculated vector coding cost to determine the rate-distortion value of the candidate predictor block.

28. A non-transitory computer-readable storage medium containing processor executable instructions which upon execution by one or more processors of a computer cause the computer to perform a method of encoding a block of pixels in an image to be encoded using INTRA block copy prediction in which the block of pixels in the image is encoded using a predictor block indicated by a block vector, said predictor block corresponding to a block pixels in the image, the method comprising:
searching the image for a predictor block by determining rate-distortion values for candidate blocks in the image and selecting a predictor block from the candidate blocks according to rate-distortion criterion, wherein
determining the rate-distortion value includes evaluating a vector coding cost corresponding to each available candidate block vector predictor.

29. A method of encoding a block of pixels in an image to be encoded using INTRA block copy prediction in which the block of pixels in the image is encoded using a predictor block indicated by a block vector, said predictor block corresponding to a block pixels in the image, the method comprising:
searching the image for a predictor block by determining costs for candidate blocks in the image and selecting a predictor block from the candidate blocks according to a cost criterion, wherein
determining the costs includes evaluating a vector coding cost of at least one candidate block vector predictor for the candidate block, and
if the candidate block vector predictor indicates a position in the image outside a two coding tree block range, the vector coding cost of the candidate block vector is evaluated.

30. Apparatus for encoding a block of pixels in an image to be encoded using INTRA block copy prediction in which the block of pixels in the image is encoded using a predictor block indicated by a block vector, said predictor block corresponding to a block pixels in the image, the apparatus comprising:
a searching unit configured to search the image for a predictor block by determining costs for candidate blocks in the image and selecting a predictor block from the candidate blocks according to a cost criterion, wherein
determining the costs includes evaluating a vector coding cost of at least one candidate block vector predictor for the candidate block, and
if the candidate block vector predictor indicates a position in the image outside a two coding tree block range the vector coding cost of the candidate block vector is evaluated.

31. A non-transitory computer-readable storage medium containing processor executable instructions which upon execution by one or more processors of a computer cause the computer to perform a method of encoding a block of pixels in an image to be encoded using INTRA block copy prediction in which the block of pixels in the image is encoded using a predictor block indicated by a block vector, said predictor block corresponding to a block pixels in the image, the method comprising:
searching the image for a predictor block by determining costs for candidate blocks in the image and selecting a predictor block from the candidate blocks according to a cost criterion, wherein
determining the costs includes evaluating a vector coding cost of at least one candidate block vector predictor for the candidate block, and
if the candidate block vector predictor indicates a position in the image outside a two coding tree block range, the vector coding cost of the candidate block vector is evaluated.

32. A method of encoding a sequence of digital images into a bitstream comprising encoding a block of pixels in an image to be encoded using INTRA block copy prediction in which the block of pixels in the image is encoded using a predictor block indicated by a block vector, said predictor block corresponding to a block pixels in the image, the method comprising:
searching the image for a predictor block by determining costs for candidate blocks in the image and selecting a predictor block from the candidate blocks according to a cost criterion, wherein
determining the costs includes evaluating a vector coding cost of at least one candidate block vector predictor for the candidate block, and
if the candidate block vector predictor indicates a position in the image outside a two coding tree block range, the vector coding cost of the candidate block vector is evaluated.

33. A non-transitory storage medium storing a bitstream encoded according to claim 32.
